(19) United States
(12) Patent Application Publication
(10) Pub. No.: US 2017/0124117 A1
(43) Pub. Date: May 4, 2017

(54) PARAMETERABLE METHOD FOR PROCESSING A FILE REPRESENTING AT LEAST ONE IMAGE

(71) Applicant: DXO LABS, Boulogne BIllancout (FR)

(72) Inventors: Jean-Marc ALEXIA, Alfortville (FR); Alexandre AUBERT, Paris (FR)

(21) Appl. No.: 15/311,988

(22) PCT Filed: May 22, 2015
(86) PCT No.: PCT/EP2015/061379

§ 371 Date: Nov. 18, 2016

(30) Foreign Application Priority Data
May 28, 2014 (FR) 1454843

(51) Int. Cl. G06F 17/30; H04L 29/08; G06F 9/54; H04N 5/232; G06T 1/00

(52) U.S. Cl. CPC G06F 17/30244; H04N 5/23229; G06T 1/0007; G06F 9/542; H04L 67/06

(57) ABSTRACT

A parameterable method for processing a file representing at least one image acquired by an image-recording device configured to be connected to a communication network. At least one file-processing action is pre-programmed carried out by a user of the device or by the device. An event is selected initiating at least one file-processing action by the user of the device or by the device. At least one image is captured by the image-recording device. The event initiating each file-processing action is detected. Each pre-programmed action on the file representing at least one captured image is implemented.

### FIELD OF THE INVENTION

The present invention is aimed at a parametrable method for processing a file representing at least one image, a device for implementing such a method and a portable communications terminal comprising such a device. The invention is notably applicable in the fields of the automatic processing of images and of the transfer of images. More particularly, the invention is applicable to the pre-programming of steps for processing and for transfer of files representing images by a user or by a device.

### PRIOR ART

Currently, in the field of photography and of image processing, some digital cameras and portable communications terminals have the possibility of carrying out an image processing and of storing the image. However, the choice of options for image processing are very limited. Moreover, the user has to manually transfer the image to its final point of storage, such as a transfer of an image to a computer for example. Portable communications terminals allow the transfer of images to social networks and an image processing. However, the user has to use an application dedicated to each of these tasks and to perform each action manually. Furthermore, for a particular image processing, the user must use software applications that are specific to image enhancement.

The application DXO OPTICS PRO (registered trade mark) allows images to be enhanced and several simultaneous exports. Nevertheless, the application has a prior requirement for the image to be transferred to a computer and an intervention of the user is needed to carry out the processing of the image. Also, pre-programming of the process to be performed is not possible. In the prior art, a method is known for correction of defects as a function of parameters that must be defined by a user, this method having been patented by the company DxO Labs in 2001.

With regard to the programming, GRAFCET (acronym for the French title “Graphe Fonctionnel de Commande Etapes/Transitions”) is a graphics language for representing the operation of a programmable logic controller (PLC). A grafcet defines steps with which are associated actions and transitions between the steps which are associated with transition conditions. However, this tool is a representation of an operation of a PLC and does not program it. Moreover, a grafcet relates to a PLC and does not allow software applications, installed on a computer for example, to be exploited. SFC (acronym for Sequential Function Chart) is a graphics programming language inspired by GRAFCET. SFC is applicable to PLCs and its limitations in terms of possible functions are similar to those of GRAFCET. Indeed, the actions and the transitions of these two languages are binary and use logical operators. The actions are therefore very limited. Furthermore, Windows Direct X (registered trademark) is another graphics programming system for sequential steps. Nevertheless, these languages are poorly adapted to image processing.

Finally, the service IFTTT (“If This Then That”) allows conditional actions to be defined. However, a concatenation of several actions is impossible and the service is focused on movement of files.

### SUBJECT OF THE INVENTION

The present invention is aimed at overcoming all or part of these drawbacks.

For this purpose, according to a first aspect, the subject of the present invention is a parametrable method for processing a file representing at least one image acquired by means of an image capture device configured so as to be connected to a communications network which comprises the following steps:
pre-programming of at least one action for processing the file by a user of the device or by the device,
selection of an event triggering at least one action for processing the file by the user of the device or by the device,
capture of at least one image by means of the image capture device,
detection of the event triggering each action for processing the file, and
implementation of each pre-programmed action on the file representing at least one captured image.

The invention has the advantage of automatically carrying out the steps for processing and transferring images based on a pre-programming by the user or by the device, more particularly as a function of later uses. These pre-programmings may be recorded and used several times whenever the triggering event is detected.

Another advantage of the invention is to automatically call up functions, software, applications needed to carry out each of the pre-programmed actions, without intervention of the user. Moreover, the image processing may relate to a fixed or a video image.

Furthermore, the invention is configured for carrying out several actions simultaneously or consecutively. Also, each action does not require a triggering event. Indeed, several actions may be carried out based on a single triggering event.

In some embodiments, an action for processing the file comprises an image processing step.

These embodiments have the advantage of allowing automation of the image processing whenever an image is captured in order to improve the quality or the sharpness of the image in accordance with the needs of the user.

In some embodiments, an action for processing the file comprises a step for editing the content of the file.

The advantage of these embodiments resides in the possibility of automatically modifying certain characteristics of the content of the file in order to correspond to criteria of authenticity or of confidentiality for example.

In some embodiments, an action for processing the file comprises a step for modification of the data and metadata of the file.

The automatic modification of the characteristics of the file according to criteria and preferences defined by the user, such as the format or the name of the file for example, is one advantage of these embodiments.

In some embodiments, an action for processing the file comprises a step for transferring the file via a communications network.

These embodiments offer the advantage of automating the transfer of the file to any given device connected to a communications network depending on criteria defined by the user.

In some embodiments, an action for processing the file comprises a step for storing the file.

One advantage of these embodiments is the possibility of storing the file at any given time after its capture. More particularly, if the file is subjected to image processing actions.

In some embodiments, the user or the device pre-programs the implementation of at least two actions simultaneously.

The advantage of these embodiments is the possibility of carrying out two actions simultaneously, more particularly when the actions carried out require a long time to perform. Furthermore, this allows an image to be transferred to two destinations simultaneously.

In some embodiments, an event triggering an action for processing the selected file is at least an adjustment of the image capture device.

These embodiments offer the advantage of allowing an action to be carried out by selecting the triggering event from amongst possible adjustments of the device. More particularly, an image processing may be adapted to the image capture mode chosen by the user.

In some embodiments, an event triggering an action for processing the file depends on the content recognized in the file.

The advantage of these embodiments is the use of image recognition techniques in order to allow the user to obtain an action adapted to the content of the image.

In some embodiments, an event triggering an action for processing the file is transmitted via a communications network.

These embodiments offer the advantage of allowing the delayed implementation of actions depending on a detection of the transmission effected via the communications network.

In some embodiments, an event triggering an action for processing the file depends on a localization of the device.

The triggering of an action when the user arrives at or leaves a certain place is one advantage of these embodiments.

In some embodiments, an event triggering an action for processing the file depends on an identification of the user.

The advantage of these embodiments is to only perform certain actions when the appropriate user uses the device. The file is better protected, in particular if its content is confidential.

In some embodiments, an event triggering an action for processing the file is a physical interaction of the user with the device.

The physical interaction of the user with the device offers the advantage of triggering actions when the device is picked up by or within range of the user. The physical interaction may also be a detection of sound levels in an environment near to the device.

In some embodiments, the method, subject of the present invention, comprises a step for recording the program of actions for processing the file pre-programmed by the user or the device and for the selection of the event triggering at least one action for processing the file by the user or the device.

These embodiments offer the advantage of allowing the user to record the series of actions and the associated triggering events so as to be able to re-use them or to share them. Furthermore, the recording may be a temporary recording carried out by the device which may be offered to the user during a later use of the device

In some embodiments, at least two images are captured during the step for capturing at least one image by means of the image capture device.

The advantage of these embodiments is to allow a merging of the two images in order to obtain a higher quality of image. Another advantage is a possibility of selecting the image that the user prefers. Furthermore, these embodiments comprise the capture of videos.

In some embodiments, the steps are carried out in a defined order.

These embodiments have the advantage of improving the speed and the efficiency of the method.

According to a second aspect, the invention is aimed at an image capture device configured so as to be connected to a communications network which comprises:
means for pre-programming at least one action for processing a file by a user of the device or by the device,
means for selection of an event triggering the action for processing the file by the user of the device or by the device,
means for recording a file representing at least one image captured by the device,
means for detection of the event triggering each action for processing the file, and
means for carrying out each pre-programmed action on the file representing the capture of at least one image.

Since the particular advantages, aims and features of the device, subject of the present invention, are similar to those of the method, subject of the present invention, they are not recalled here.

According to a third aspect, the invention is aimed at a portable communications terminal which comprises a device, subject of the present invention.

Since the particular advantages, aims and features of the portable communications terminal, subject of the present invention, are similar to those of the device, subject of the present invention, they are not recalled here.

### BRIEF DESCRIPTION OF THE FIGURES

Other advantages, aims and features of the invention will become apparent from the non-limiting description that follows of at least one particular embodiment of the parametrable method for processing a file representing at least one image, of the image capture device and of the portable communications terminal comprising such a device, with regard to the appended drawings, in which:

FIG. 1 shows, in the form of a flow diagram, one embodiment of the method, subject of the present invention,

FIG. 2 shows, schematically, one embodiment of the device, subject of the present invention,

FIG. 3 shows, schematically, one embodiment of the portable communications terminal, subject of the present invention,

FIG. 4 shows, schematically, one embodiment of a user interface of the device in its initial state,

FIG. 5 shows, schematically, one embodiment of a user interface of the device during the creation of a series of actions and of triggering events and

FIG. 6 shows, schematically, one embodiment of a user interface when the creation of the series of actions and of triggering events has finished.

### DESCRIPTION OF EMBODIMENTS OF THE INVENTION

It is noted, from the outset, that the figures are not to scale.

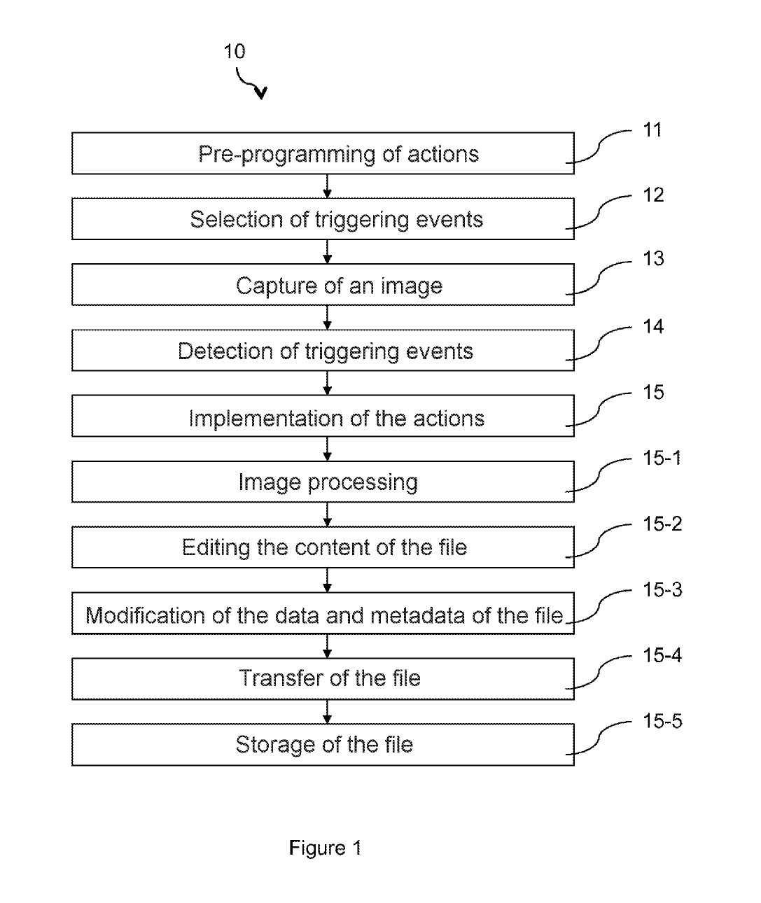

FIG. 1 shows one particular embodiment of a parametrable method for processing a file representing at least one image acquired by means of an image capture device configured so as to be connected to a communications network which comprises the following steps:
pre-programming 11 of at least one action for processing the file by a user of the device or by the device,
selection 12 of an event triggering at least one action for processing the file by the user of the device or by the device,
capture 13 of at least one image by means of the image capture device,
detection 14 of the event triggering each action for processing the file, and
implementation 15 of each pre-programmed action on the file representing at least one captured image.

The step 15 is decomposed into five sub-steps:
an image processing step 15-1,
a step 15-2 for editing the content of the file,
a step 15-3 for modifications of the data and metadata of the file,
a step 15-4 for transferring the file via a communications networks
a step 15-5 for storing the file.

For the following part of the description, an image capture is defined as being the product of the image capture device. More particularly, image capture relates to a still image or a video.

The step 11 for pre-programming at least one action for processing the file is carried out by the user of the device or by the device. In the case of a pre-programming by the user, the user chooses each action which will be applied to the image from amongst a library of actions. The actions may be grouped into various toolboxes included in the library of actions. These toolboxes are preferably:
the box grouping the actions for modification of the captured image,
the box grouping the actions for sharing the captured image, and
the box grouping the actions printing the captured image.

The actions can be actions for:
image processing,
editing of the content of the file,
modification of the data and metadata of the file,
transfer of the file via a communications network,
storage of the file.

During the pre-programming step 11, the user can pre-program at least one action for processing the file but also the parameters of each action. In addition, the user can define an order in which the actions are executed. Several actions may be carried out simultaneously.

In the case of a pre-programming by the device, the device can suggest to the user the latest chain of actions carried out. The device can suggest one or more chains of actions frequently selected by the user. The device may also, using image recognition for example, suggest a suitable chain of actions.

The step 12 allows the triggering events associated with the actions for processing the file to be selected. If the action 12 is carried out by the user, the user can select the triggering events from within a list which comprises:
criteria for adjustment of the image capture device,
a recognition of the content of the captured image,
a transmission carried out via a communications network,
a localization of the device,
an identification of the user, and
a physical interaction of the user with the device.

The criteria for adjustment of the image capture device may be predefined modes of image capture such as macro, panorama or portrait modes for example. The adjustment criteria may also be a black and white mode or a detection of a certain level of zoom.

The recognition of the content of the captured image may be a facial recognition, a recognition of a scene or a recognition of a smile. The recognition of the content of the captured image may also be a recognition of the predominant color, the average brightness, the average contrast, the average level of sharpness or the uniformity level of the colors.

The transmission via a communications network may be the detection of a connection to a social network, the detection of a connection to an email account, the detection of a notification or the detection of an NFC (Near-Field Communications) network. The transmission may also be a detection of publication or of event on a social network, a detection of receipt or of transmission of a message of the SMS (acronym for “Short Message Service”) or MMS (acronym for “Multimedia Messaging Service”) type. More generally, the transmission may be of the receiving information or sending information type across a communications network.

A localization of the device may be:
a global positioning, by means of a GPS (acronym for “Global Positioning System”) for example
a detection of a globally locatable telecommunications network, of the Wi-Fi (acronym for “Wireless Fidelity”, registered trademark) type for example, or
a localization by means of a localized social network.

An identification of the user may be carried out by means of a secret code, of a fingerprint recognition or of a facial recognition.

A physical interaction may be the detection of a certain volume of music, of a voice command, of a sudden movement of the device, an orientation of the device, a specific connection or a temperature.

A triggering event may be a combination of at least two elements selected from amongst the elements listed hereinabove.

A triggering event may be implemented during a series of actions. The triggering event implemented can then trigger a sub-set of actions.

A pre-programming of a series of actions and of triggering events may be recorded and reused for various image captures for which the device detects the same triggering events. A stored pre-programming can be automatically implemented by the device during further uses of the device as soon as it has been recorded.

A graphics interface allowing the pre-programming of at least one action and the selection of at least one triggering event is composed of boxes that the user can fill in with an action or with a triggering event by dragging a representation of an action or of a triggering event into an empty box. The graphics interface comprises at least one row of boxes, and the user can create other branches.

In the case of a selection by the device, the device may suggest to the user the latest chain of actions carried out. The device may suggest one or more chains of actions frequently selected by the user. The device may also, using image recognition for example, suggest a suitable chain of actions. The device may also suggest a triggering event frequently used for each pre-programmed action in the step 11.

In some embodiments, the selection of triggering events is not carried out by the user or by the device, the triggering event is then defined by default by the method as being the end of the capture of the image. More particularly, in some embodiments, all the pre-programmed actions are carried out at the same time as soon as the image is captured. In other embodiments, the selection of triggering events is not carried out by the user, the triggering event is then defined by default by the method as being the end of the capture of the image for the implementation of the step 15-1. The end of the preceding step is the event triggering the action immediately following. For example, the step 15-1 has been processed by the device, then the step 15-2 is implemented.

The step 13 for capture of at least one image by means of the image capture device is a step for capture of a video or of a fixed image. In some embodiments, the device can automatically capture a series of 2 to 6 consecutive fixed images within a lapse of time of less than one second. The device can mix them and reduce the noise on the final fixed image which is the captured image used.

The step 14 for detection of the event triggering each action for processing the file may be a step for detecting a change of state of one of the components of the device.

The step 15 for performing each pre-programmed action on the file representing at least one captured image is decomposed into five sub-steps which may be carried out simultaneously or consecutively. Each sub-step representing a pre-programmed action may have a different number of triggering events which may be of different natures. A step representing a pre-programmed action does not necessarily have a triggering event; in this case, the step is carried out automatically according to the order defined by the user or by the device.

The five sub-steps are:
an image processing step 15-1,
a step 15-2 for editing the content of the file,
a step 15-3 for modifications of the data and metadata of the file,
a step 15-4 for transferring the file via a communications network
a step 15-5 for storing the file.

The image processing step 15-1 may be a step from amongst the following non-exhaustive list:
application of artistic filters such as a texture for example,
application of a silver rendering,
modification of the exposure,
modification of the contrast,
softening of the skin textures, in the case where a face is detected,
blurring or masking of the faces if a face is detected or
whitening of the teeth, if a smile is detected.

The step 15-2 for editing the content of the file is for example:
a modification of the resolution of the captured image,
a modification of the definition of the captured image,
an encryption or an encoding of the captured image,
an application of an authenticating watermark into the captured image,
an application of an information watermark, such as a QR Code for example,
an addition of credits at the end of a video,
an application of a virtual framing, or
a modification of the captured image and, more particularly, of the trim or the application of photographic rules such as the rule of thirds for example.

The step 15-3 for modifications of the data and metadata of the file can be:
a modification of the name of the file according to a rule predefined by the user,
a modification of the format of the file,
a compression of the captured image in the zip format, in the case where a filter and, more particularly, a firewall does not allow images to be received or sent for example,
an addition or an editing of the global positioning data recorded when the image is captured,
a metadata allowing the identification by Tag or semantic markers, more particularly of people or of places, or
an editing of the metadata and, more particularly, the metadata of the type EXIF (acronym for “Exchangeable Image File Format”) or IPTC IIM (acronym for “International Press Telecommunication Council Information Interchange Model”).

The modification of the data or metadata of the file may be useful in the case of crypto-professional uses of the method.

The step 15-4 for transferring the file via a communications network may be:
a transfer of the file to a storage space,
a publication of the file on a social network,
a transmission of the file by message, more particularly by electronic message, SMS or MMS,
a transmission by FTP (File Transfer Protocol),
a publication on an internet page, and more particularly of the blog type, or
a transfer to a storage space of the Cloud type.

The step 15-5 for storing the file provides the user with the possibility of conserving a copy of the captured image. This step may be carried out prior to and/or after modification of the file.

In some embodiments, the steps 15-1, 15-2, 15-3, 15-4 and 15-5 are carried out in a different order. Indeed, these steps are interchangeable. In some embodiments, the steps 15-1, 15-2, 15-3, 15-4 and 15-5 can have several occurrences. In some embodiments, at least one step from amongst the steps 15-1, 15-2, 15-3, 15-4 and 15-5 is non-existent. In some embodiments, one of the steps 15-1, 15-2, 15-3, 15-4 and 15-5 has several occurrences, but does not carry out the same action. For example, the method implements two steps 15-1, the first step 15-1 being a modification of the contrast and the second step 15-1 a modification of the exposure.

The steps 15-1, 15-2, 15-3, 15-4 and 15-5 correspond to the actions pre-programmed by the user. The steps 15-1, 15-2, 15-3, 15-4 and 15-5 carry out the action desired by the user defined by the user when the triggering event takes place.

In some embodiments, a step for recording actions and triggering events defined by the user is carried out after the step 12 and prior to the step 13. The recording step may be carried out automatically by the device.

In the step 11, the device may suggest a recording carried out during a prior use. The device may also record a number of uses of a pre-programmed chain and suggest to the user between one and ten frequently used pre-programmed chains. The chains suggested may be categorized by number of uses, by frequency of use or because the chain suggested is the latest used by the user.

The device may carry out a chain of pre-programmed actions on a series of photos without requesting the agreement of the user if, for example, the photos are taken with a maximum separation of 30 minutes.

In some embodiments, a step for sharing the recording carried out in the preceding step is implemented after the recording step and prior to the step 13. More particularly, the recording may be shared over the Internet, via social networks or by a transmission via a communications network.

In some embodiments, a step for importing a series of actions and of triggering events is carried out before the step 11 for pre-programming actions for processing the file.

The method 10 can be implemented by a device 20.

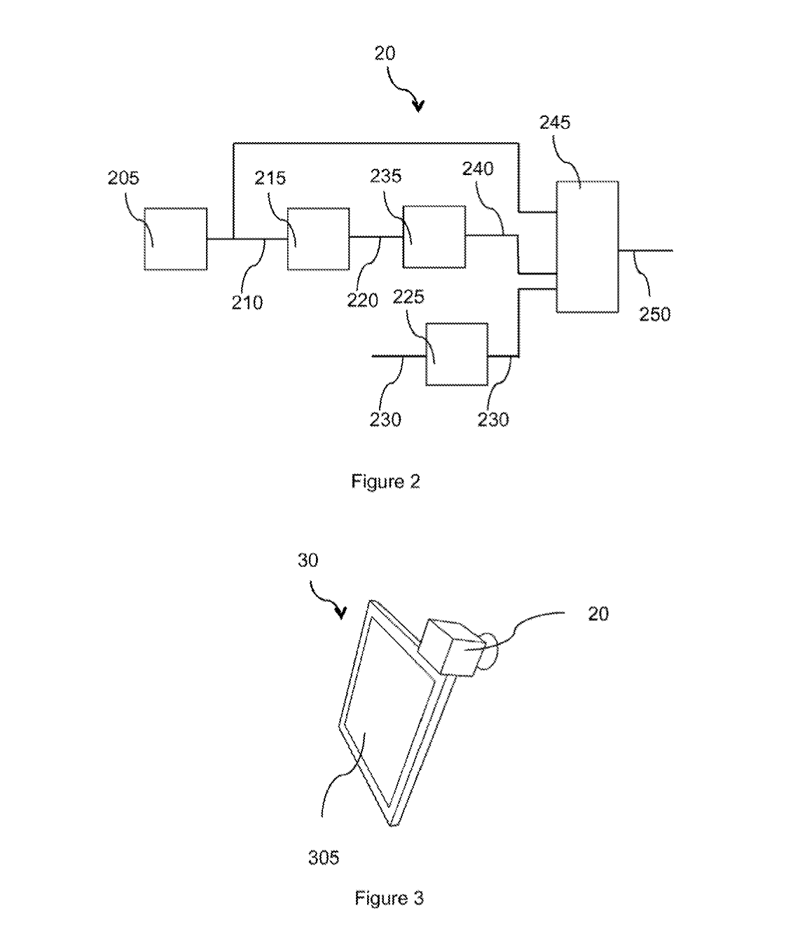

FIG. 2 shows one embodiment of an image capture device configured so as to be connected to a communications network which comprises:
means 205 for pre-programming at least one action 210 for processing a file 230 by the user of the device or by the device,
means 215 for selection of an event 220 triggering the action 210 for processing the file 230 by the user of the device or by the device,
means 225 for recording a file 230 representing at least one image captured by the device,
means 235 for detection of the event 220 triggering each action 210 for processing the file 230, and
means 245 for carrying out each pre-programmed action 210 on the file 230 representing at least one captured image.

The means 205 for pre-programming the action 210 is, for example, a microprocessor. The means 205 may comprise a means for interacting with the user such as a keyboard or a touchscreen for example. The command for the action 210 is transmitted to the means 215 for selecting a triggering event and by means 245 for carrying out the pre-programmed action 210. In some embodiments, the signal 210 may represent several actions pre-programmed by the user or by the device according to the step 11 of the method 10.

The means 215 for selecting the triggering event 220 is for example a microprocessor. The means 215 may comprise a means for interacting with the user such as a keyboard or a touchscreen for example. In some embodiments, the means 205 for pre-programming an action and the means 210 for selecting a triggering event are one single means. In some embodiments, the signal 215 may represent several triggering events according to the step 12 of the method 10. In some embodiments, the user or the device does not select any triggering event and the means 215 for selecting the triggering event selects the default triggering event. More particularly, the default triggering event is the capture of at least one image by the device 20. The command for the triggering event 220 associated with the action 210 is transmitted to the means 235 for detection of the event 220 triggering each pre-programmed action 210 for processing the file 230.

The means 225 for recording a file 230 representing at least one image captured by the device is, for example, an assembly comprising a micro-processor and a storage means, the storage means being for example a hard disk, or a memory card. The file 230 representing at least one captured image is transmitted to the means 245 for performing each pre-programmed action 210 on the file 230 representing at least one captured image.

The means 235 for detection of the triggering event is a micro-processor for example. The means 235 for detection of the triggering event can analyze the various changes of state of the device in order to detect a change of state corresponding to the triggering event. The command 240 for detection of the triggering event is transmitted to the means 245 for performing each pre-programmed action 210 on the file 230 representing at least one captured image.

The means 245 for performing each pre-programmed action 210 on the file 230 representing at least one captured image is, for example, a micro-processor. The means 245 carry out each pre-programmed action 210 on the file 230. The file modified according to the defined chain of actions is the information 250 at the output of the means 245.

In some embodiments, the means 245 comprises a display means on which the file 230 and the file 250 can be displayed.

In some embodiments, the device 20 may comprise a means for recording a chain of pre-programmed actions and a means for counting the recorded number of uses of a chain of pre-programmed actions.

FIG. 3 shows one embodiment of a portable communications terminal 30 which comprises a device, subject of the present invention.

The portable communications terminal comprises a device 20 and a display means 305. The display means 305 allows the information 230 and/or the information 250 to be displayed. In order to carry out each pre-programmed action 210, the device 20 may have access to the various means of the portable communications terminal 30. More particularly, the device 20 may have access to the stored data and also to the programs installed on the portable communications terminal 30.

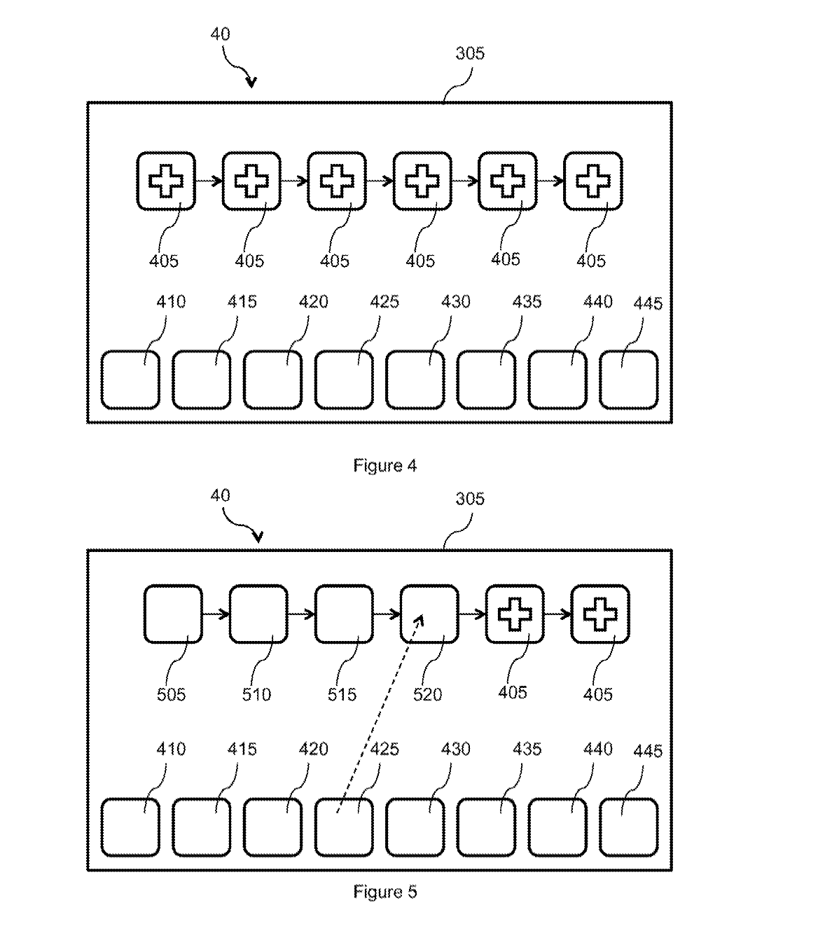

FIG. 4 shows one embodiment of a user interface 40 in its initial state. The interface 40 may be displayed on a screen 305 of a portable communications terminal 30. The interface 40 may be used by the user for:
pre-programming at least one action 210 for processing the file 230 representing at least one image,
selecting the event 220 triggering the action 210 for processing the file 230, or
recording a series of pre-programmed actions and of triggering events.

In the initial state, between five and ten empty boxes 405 are displayed. The empty boxes 405 may correspond to a triggering element 220 or to an action 210. The boxes can define an order in which the actions are carried out or a triggering event is detected. The defined order is preferably implemented from left to right. The boxes 405 are preferably connected by arrows oriented from left to right representing the order of implementation.

The boxes 410, 415, 420, 425, 430, 435, 440 and 445 may represent actions or triggering events, preferably belonging to the same toolbox. The boxes 410, 415, 420, 425, 430, 435, 440 and 445 may be interchangeable. The boxes 410, 415, 420, 425, 430, 435, 440 and 445 may display a symbol representing their function. The boxes 410, 415, 420, 425, 430, 435, 440 and 445 may represent the actions and triggering events defined in the description of the method 10 shown in FIG. 1.

The box 410 may represent an action for application of a filter. The box 415 may represent an action for application of a silver rendering. The box 420 may represent an action for application of an authenticating watermark. The box 425 may represent an action for modification of the size of the image. The box 430 may represent an action for sharing over a social network. The box 435 may represent an action for storing on a remote server in the Cloud. The box 440 may represent a global positioning as a triggering event. The box 445 may represent a voice command as a triggering event.

In some embodiments, the boxes for the chain of actions are pre-filled in according to the latest chain of pre-programmed actions implemented. In some embodiments, the user can select, from within a list of chains of actions, a chain suggested depending on its number of uses for example.

FIG. 5 shows one embodiment of a user interface 40 during the creation of a series of actions and of triggering events. The interface 40 may be displayed on a screen 305 of a portable communications terminal 30.

The first box of the series of actions and of triggering events is the box 505. The box 505 may be an empty box 405 filled in by the user with a box representing a voice command 445 as triggering event. The user has dragged the box 445 onto the location of the first empty box 405 for example, yielding the box 505.

The box 510 is the next box of the series; it represents, for example, an action for application of a silver rendering whose box 415 has been deposited into the empty box 405 at second position in the series. According to the same principle:
the box 515 following the box 510 may be an action for application of an authenticating watermark 420,
the box 520 following the box 515 may be an action for modification of the size of the image 425 which has just been deposited by the user.

The boxes following the box 520 are empty boxes 405. The number of empty boxes 405 can be in the range between one and a hundred.

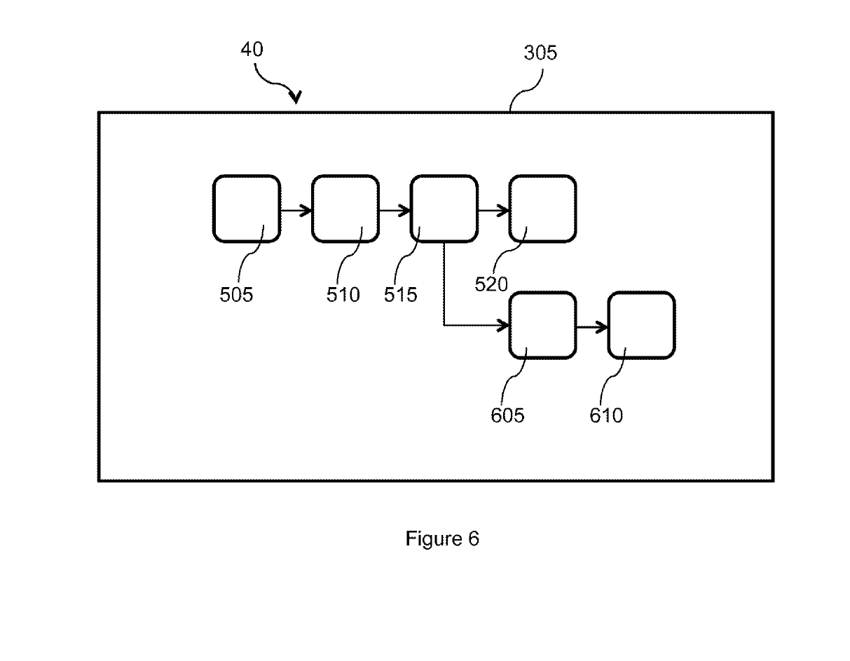

FIG. 6 shows one embodiment of a user interface when the creation of the series of actions and of triggering events is finished. The interface 40 may be displayed on a screen 305 of a portable communications terminal 30.

The boxes 505, 510, 515 and 520 previously placed have the same position. An action box 605 is positioned on a second row of boxes. A transition starting from the box 515 and arriving at the box 605 indicates that the action represented in the box 605 is carried out simultaneously with the action represented in the box 515.

A box 610 is positioned after the box 605 and represents, for example, an action for sharing over a social network.

In some embodiments, the box 515 is a triggering event. In these embodiments, when the triggering event represented by the box 515 is detected, the actions 520 and 605 are implemented.

1-18. (canceled)

19. A parametrable method for processing a file representing at least one image acquired by an image capture device configured to be connected to a communications network, comprising the steps of:
pre-programming at least one action to process the file by a user of the image capture device or by the image capture device;
selecting an event to trigger said at least one action;
capturing at least one image by the image capture device;
detecting the event triggering each action; and
executing each pre-programmed action, whose triggering event has been detected, on the file representing at least one captured image.

20. The parametrable method as claimed in claim 19, wherein said at least one pre-programmed action comprises an image processing step.

21. The parametrable method as claimed in claim 19, wherein said at least one pre-programmed action comprises a step for editing content of the file.

22. The parametrable method as claimed in claim 19, wherein said at least one pre-programmed action comprises a step for modifying data and metadata of the file.

23. The parametrable method as claimed in claim 19, wherein said at least one pre-programmed action comprises a step for transferring the file via the communications network.

24. The parametrable method as claimed in claim 19, wherein said at least one pre-programmed action comprises a step for storing the file.

25. The parametrable method as claimed in claim 19, further comprising the step of pre-programming an implementation of at least two actions simultaneously by the user or by the image capture device.

26. The parametrable method as claimed in claim 19, wherein said event triggering an action is at least an adjustment of the image capture device.

27. The parametrable method as claimed in claim 19, wherein said event triggering an action depends on content recognized in the file.

28. The parametrable method as claimed in claim 19, wherein said event triggering an action is transmitted via the communications network.

29. The parametrable method as claimed in claim 19, wherein said event triggering an action depends on a localization of the image capture device.

30. The parametrable method as claimed in claim 19, wherein said event triggering an action depends on an identification of the user.

31. The parametrable method as claimed in claim 19, wherein said event triggering an action is a physical interaction with the user of the image capture device.

32. The parametrable method as claimed in claim 19, further comprising a step for recording said pre-programmed actions for processing the file and said selected event selected for triggering said at least one action for processing the file.

33. The parametrable method as claimed in claim 19, wherein at least two images are captured by the image capture device.

34. The parametrable method as claimed in claim 19, further comprising a step of performing the steps of pre-programming, selecting, capturing, detecting and executing in order.

35. An image capture device configured to be connected to a communications network, comprising a memory; and a processor to pre-program at least one action to process a file by a user of the image capture device or by the image capture device, selecting an event triggering said at least one action, recording in the memory the file representing at least one image captured by the image capture device, detecting the event triggering each action for processing the file, and performing each pre-programmed action, whose triggering event has been detected, on the file representing at least one captured image.

36. A portable communications terminal comprising the image capture device as claimed in claim 35.
